(19) United States
(12) Patent Application Publication
(10) Pub. No.: US 2014/0297996 A1
(43) Pub. Date: Oct. 2, 2014

(54) MULTIPLE HASH TABLE INDEXING

(71) Applicant: ADVANCED MICRO DEVICES, INC., Sunnyvale, CA (US)

(72) Inventor: Ramkumar Jayaseelan, Austin, TX (US)

(73) Assignee: Advanced Micro Devices, Inc., Sunnyvale, CA (US)

(21) Appl. No.: 13/854,171

(22) Filed: Apr. 1, 2013

(51) Int. Cl. G06F 9/38

(52) U.S. Cl. CPC G06F 9/3804
USPC 712/239

(57) ABSTRACT

A processor includes storage elements to store a first and second value, as well as a plurality of hash units coupled to the storage elements. Each hash unit performs a hash operation using the first value and the second value to generate a corresponding hash result value. The processor further includes selection logic to select a hash result value from the hash result values generated by the plurality of hash units responsive to a selection input generated from another hash operation performed using the first value and the second value. A method includes predicting whether a branch instruction is taken based on a prediction value stored at an entry of a branch prediction table indexed by an index value selected from a plurality of values concurrently generated from an address value of the branch instruction and a branch history value representing a history of branch directions at the processor.

### BACKGROUND

1. Field of the Disclosure

The present disclosure relates generally to hash table indexing in a processor and more particularly to branch prediction table indexing for branch prediction in a processor.

2. Description of the Related Art

A hash operation using two values often is used to generate an index for a corresponding entry of a table. As a hash operation using values of K bits can generate 2^{K} possible hash values, the table typically is implemented with at least 2^{K} entries. However, a pattern or usage of the two values often can lead to only a small subset of the entries of table being used in practice, which results in wasted space and power due to the unused entries of the table. As an example, many processors employ a two-level adaptive branch predictor that employs a single hash operation in the form of a bitwise operation of past branch history and the address of a branch instruction. The branch predictor uses the result to index into a branch prediction table to access the predicted taken/not-taken direction of the branch. However, for many workloads, this conventional hash indexing results in the utilization of only a subset of the entries of the branch prediction table as many of the dynamic branch instructions alias into this subset of entries. The underutilization of branch predictor tables and other hash-indexed tables leads to unnecessary circuitry, wasted silicon floor space, and wasted power consumption in order to support the unused entries of the branch prediction table.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating an instruction execution pipeline of a processor that utilizes a branch predictor with multiple-hash indexing in accordance with some embodiments.

FIG. 2 is a block diagram illustrating the branch predictor of FIG. 1 in greater detail in accordance with some embodiments.

FIG. 3 is a flow diagram illustrating a method for designing and fabricating an integrated circuit (IC) device in accordance with some embodiments.

### DETAILED DESCRIPTION

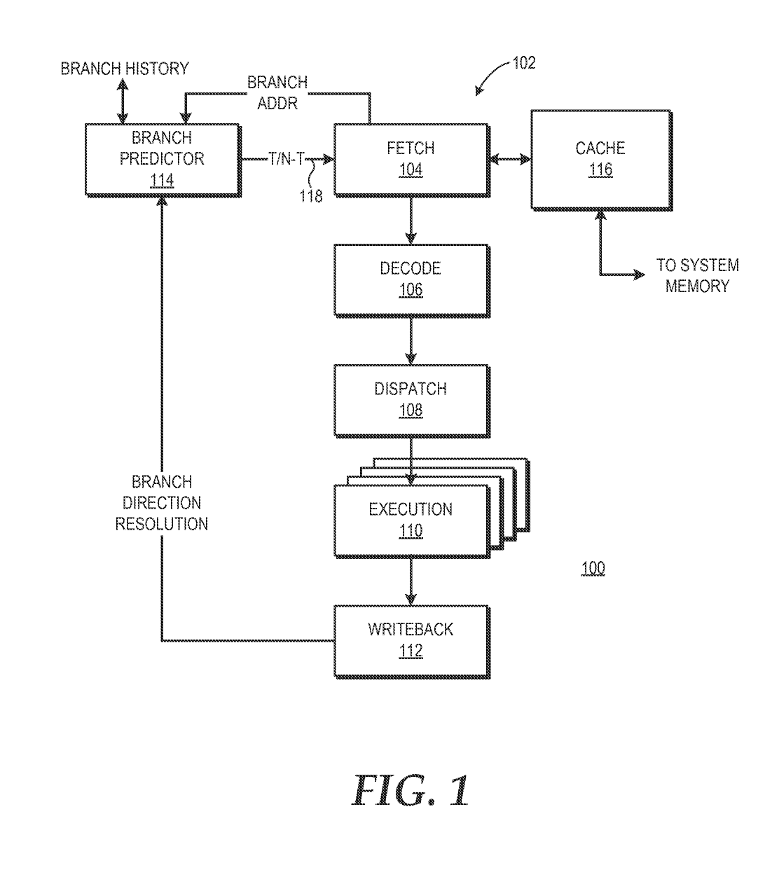

FIGS. 1-3 illustrate example techniques for employing multiple hash operations in an electronic system to index entries of a table so as provide more distributed utilization of the entire table. In accordance with some embodiments, each hash unit of a set of hash units performs a hash operation using two values to generate a corresponding hash result value. Selection logic then selects between the multiple hash result values to provide an index value. In some embodiments, the selection logic employs another hash operation to generate another hash result value, and the selection logic selects the hash result value to be provided as the index value based on this other hash result value. The hash result value selected as the index value is then used to select, or index, an entry of a table. The contents of the indexed entry then may be used to influence or control one or more processes performed at the electronic system.

For ease of illustration, various embodiments of multiple-hash table indexing techniques are described in the example context of a two-level adaptive training branch predictor. Branch predictors typically use one or more branch prediction tables that capture the correlation between past branch history and branch direction, that is, taken (T) or not-taken (N-T). Conventional branch prediction approaches utilize a single hash operation to index the branch prediction tables, which in practice often causes a few entries of the branch prediction table to be used since multiple dynamic branches alias into the same subset of entries. In contrast, applying multiple hash operations to the branch history and the address of the branch instruction being predicted, and then selecting an index value from among the generated hash results using another hash operation of the branch history and address aids in spreading the usage of the branch prediction table over a larger number of entries. In doing so, more entries participate in the branch prediction process, which results in reduced aliasing effects caused by multiple branches/branch histories overwriting each other's training information and which permits the capture of correlations of longer branch histories within a smaller branch prediction table. These techniques also may be implemented in other processor front-end predictors, such as a local history branch predictor, a perceptron-based branch predictor, an indirect branch predictor, a branch target buffer (BTB) for a branch target predictor, and the like. Moreover, such techniques are not limited to branch prediction, but also may be used to provide more evenly-spread table indexing for any of a variety of electrical system components that are susceptible to index aliasing.

FIG. 1 illustrates a processor 100 implementing a multiple-hash-indexed branch prediction table in accordance with some embodiments. The processor 100 may be employed in any of a variety of electronic systems, such as a personal computer, a smart phone, a tablet computer, an electronic book reader, a printer, a video game console, and the like. The processor 100 includes an instruction execution pipeline 102 configured to fetch instructions from a system memory (not shown) and to execute the fetched instructions, which manipulate the hardware of the processor 100 to perform various corresponding operations. To this end, the instruction execution pipeline 102 includes a fetch stage 104, a decode stage 106, a dispatch stage 108, an execution stage 110, and a writeback stage 112 (also often referred to as a “retire stage”). The instruction execution pipeline 102 further includes a branch predictor 114 and a cache 116.

In operation, the fetch stage 104 fetches blocks of instruction data from system memory and caches the fetched instruction data in the cache 116, which can comprise an instruction cache or a unified cache storing both instruction data and operand data. Based on instruction flow and a program counter (PC)(not shown), the fetch stage 104 provides instruction data from the cache 116 to the decode stage 106. At the decode stage 106, the instruction data is decoded into one or more instruction operations and the fetch of operand data for the instruction operations is initiated. At the dispatch stage 108, the decoded instruction operations are buffered until their operand data is available and one of the execution units at the execution stage 110 is available, at which point the instruction operation is dispatched to the available execution unit. The execution units can include arithmetic logic units (ALUs, or “integer units), floating point units (FPUs), and the like. When the execution of the instruction operation has correctly completed, the writeback stage 112 writes the results and any modified data back to a register file (not shown), thereby completing the processing and execution of the instruction operation.

The fetch stage 104 may employ one or more front-end prediction mechanisms to permit the instruction execution pipeline 102 to speculatively execute one or more alternative instruction paths before the actual correct instruction path is resolved. To illustrate, the fetched instructions may include dynamic branch instructions (also known as “conditional branches”) whereby the direction (i.e., taken or not-taken) of the branch depends on the result of another instruction. When a dynamic branch instruction is encountered in the fetched instruction stream, it often is advantageous to predict whether the branch instruction will be taken or not taken, and then fetch and execute an instruction stream in accordance with the prediction. In the event that the prediction was correct, the instruction execution pipeline 102 will be further along the correct instruction stream path than would be the case if the instruction execution pipeline 102 had waited for actual resolution of the direction of the branch instruction. In the event that the prediction was incorrect, the instruction execution pipeline 102 performs a flush operation to “rewind” or undo all of the architectural state changes made as a result of the misprediction of the direction of the branch instruction. If the branch prediction training is effective, the rate of accurate predictions typically significantly exceeds the rate of mispredictions, thereby providing an overall efficiency gain despite rewind setbacks due to the occasional branch misprediction.

In the illustrated example, the branch predictor 114 provides branch direction predictions for dynamic branch instructions encountered in the instruction stream fetched at the fetch stage 104. In some embodiments, the branch predictor 114 is implemented as a two-level adaptive branch predictor that maintains information representative of a history of branch directions, or “branch history,” and based on the branch history and the address of a branch instruction, predicts the direction of the branch instruction. This prediction is performed using a branch prediction table that stores branch prediction values. The branch prediction values each can be represented as a saturating counter value indicating a corresponding direction prediction, and a strength of the direction prediction. In some embodiments, the branch predictor 114 performs a plurality of hash operations to generate a corresponding plurality of hash result values, picks an index value from among the plurality of hash result values, and then indexes an entry of the branch prediction table to obtain the branch prediction value stored therein. The branch predictor 114 then provides a direction prediction indicator 118 based on the branch prediction value to the fetch stage 104, which speculatively fetches instructions and provides them to the subsequent stages for execution based on the predicted branch direction.

When the condition controlling the direction of the branch instruction is resolved, the writeback stage 112 signals the resolved condition or an indication of the actual direction of the branch instruction to the branch predictor 114, which then updates the corresponding branch prediction value by accessing the corresponding entry through the same multiple-hash index process used to obtain the branch prediction value in the first place. The branch predictor 114 then updates the branch prediction value to reflect the most recent resolved branch direction for the branch instruction, and stores the updated branch prediction value to the accessed entry of the branch prediction table. Through this hash-function-based indexing, the branch prediction table is trained over time to reflect correlations between past branch history and direction. Thus, the branch history used by the branch predictor 114 can include a global branch history that is reflective of all previous branch instructions in the instruction stream or a local branch history that is reflective of only a particular class of previous branch instructions, such as those associated with a particular branch instruction, a particular branch type, and the like.

In some embodiments, the branch predictor 114 uses the branch prediction value as the sole input for predicting the branch direction. In other embodiments, the branch predictor 114 employs multiple prediction mechanisms and then selects or combines the various resulting branch prediction inputs to arrive at an ultimate or final branch prediction. For example, the branch predictor 114 can employ a hybrid predictor that uses a two-level adaptive branch prediction mechanism as described herein to generate one direction prediction for a branch instruction and a perceptron-based branch prediction mechanism to generate another direction prediction for the branch instruction, and then select as the final direction prediction one of the two direction predictions based on, for example, an evaluation of the recent relative accuracies of the two different prediction mechanisms.

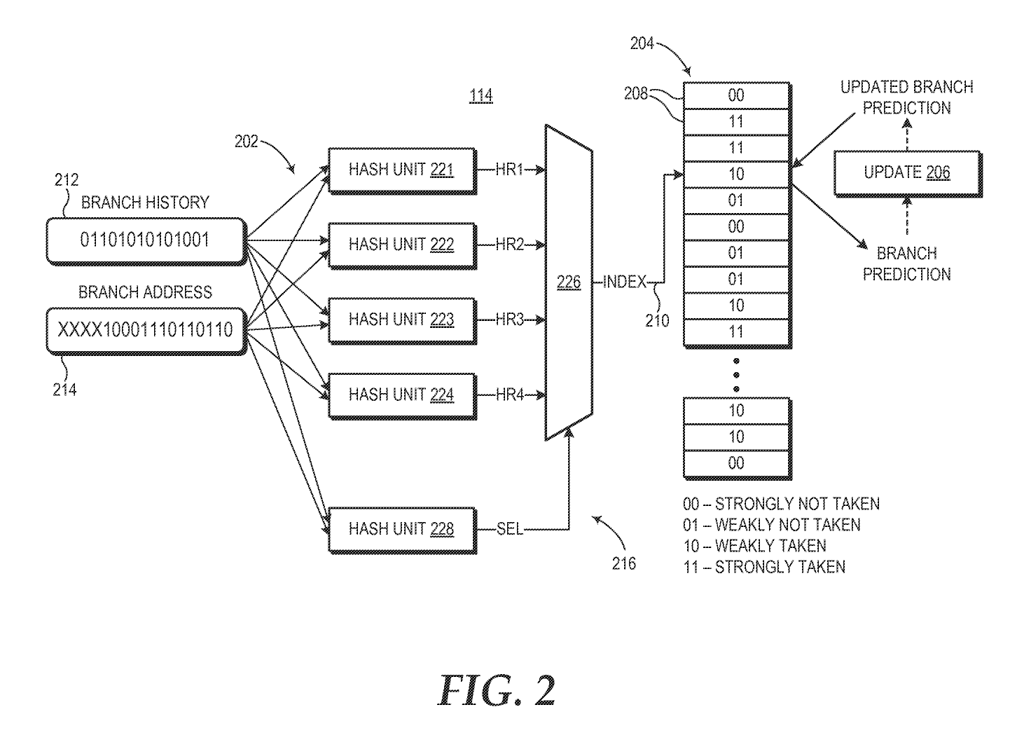

FIG. 2 illustrates a two-level adaptive branch prediction implementation of the branch predictor 114 in greater detail in accordance with some embodiments. In the depicted implementation, the branch predictor 114 includes indexing logic 202, a branch prediction table 204, and prediction update logic 206.

The branch prediction table 204 includes a plurality of entries 208, each entry 208 storing a branch prediction value and capable of being accessed via a corresponding index value. The branch prediction table 204 may be implemented using any of a variety of storage structures, such as a register file, a content addressable memory (CAM), a portion of a cache or a portion of a memory, and the like. The branch predictor 114 uses the branch prediction table 204 to capture and reflect correlations of past branch history and branch direction through training of the branch prediction values stored at each entry 208. The branch prediction values may take the form of a saturating counter value that can range from one value representing a strongly not-taken prediction to another value representing a strongly-taken prediction, and with zero or more taken or not-taken predictions of various strengths in between. For purposes of illustration, the branch prediction values are described in the example context of a two-bit branch prediction value, whereby the value “00” indicates a “strongly not-taken” prediction, the value “01” indicates a “weakly not-taken” prediction, the value “10” indicates a “weakly taken” prediction, and the value “11” indicates a “strongly taken” prediction.

In response to a branch instruction encountered in the instruction flow of the instruction execution pipeline 102 (FIG. 1), the branch predictor 114 uses the indexing logic 202 to generate an input index value 210 used to select and access a corresponding entry 208 of the branch prediction table 204, and thus select and access the branch prediction value stored therein. The accessed branch prediction value then may be used to provide the direction prediction indicator 118 (FIG. 1) indicating the direction prediction of the branch instruction. In implementations whereby the illustrated two-level adaptive branch prediction process is the sole mechanism used to predict the branch direction, the branch predictor 114 can configure the direction prediction indicator 118 to indicate either “taken” or “not-taken” based on whether the branch prediction value indicates a taken prediction (e.g., “10” or “11”) or a not-taken prediction (e.g., “00” or “01”). In other implementations whereby the illustrated two-level adaptive branch prediction process is one of multiple branch prediction mechanisms used to predict the branch direction, the branch predictor 114 can combine the branch prediction value with other branch prediction inputs from other approaches to determine a final direction prediction for provision as the direction prediction indicator 118.

When the actual direction of the branch instruction is resolved (that is, when the condition upon which the branch instruction was predicated is resolved), the prediction update logic 206 can use the indexing logic 202 to access the same entry 208 to obtain the branch prediction value, update the branch prediction value based on the resolved actual branch direction, and then store the updated branch prediction value to the indexed entry 208. To illustrate, if the original branch prediction value is “01” indicating a “weakly not-taken” direction prediction and the actual direction was resolved as “not-taken”, then the prediction update logic 206 can decrement the branch prediction value, resulting in an updated branch prediction value of “00”, thereby indicating a “strongly taken” direction prediction. As another example, if the original branch prediction value is “01” indicating a “weakly not-taken” direction prediction and the actual direction was resolved as “taken”, then the prediction update logic 206 can increment the branch prediction value, resulting in an updated branch prediction value of “10,” thereby indicating a “weakly taken” direction prediction.

The indexing logic 202 comprises storage elements 212 and 214, selection logic 216, and a plurality of hash units, such as hash units 221, 222, 223, and 224 (collectively, “hash units 221-224”). The storage elements 212 and 214 can comprise any of a variety of storage elements, such as registers, sets of latches or flip-flops, cache locations or memory locations, and the like. The storage element 212 stores a bit sequence representative of a recent branch history, whereby the bit value at a particular bit position indicates the branch direction taken at that point in the branch history. Thus, a “0” at a bit position indicates that a corresponding prior branch was not taken, whereas a “1” at the bit position indicates that the corresponding prior branch was taken. The branch history value represents a sliding window of the branch history, and thus the storage element 212 may be implemented as, for example, a shift register whereby after a direction for a branch instruction is resolved, the prediction update logic 206 shifts in the appropriate bit value for the direction, which results in the least recent branch direction being shifted out of the shift register. The storage element 214 stores an address associated with the branch instruction. The address can include, for example, a virtual address, intermediate address, or physical address of the branch instruction, or some portion thereof. As another example, the address could include the program counter (PC) at the point at which the branch instruction was encountered in the instruction flow.

Each of the hash units 221-224 include logic to generate a corresponding hash result value by performing a hash operation using a subset of bits of the branch history value stored in the storage element 212 and a subset of bits of the address value stored in the storage element 214. Any of a variety of hash functions, such as exclusive-OR (XOR) function or concatenation function, may be implemented by the hash units 221-224. Each hash unit differs from the other hash units based on the subset of bits input to the hash unit, the hash function performed, or both. In some embodiments, the hash units 221-224 each may perform the same hash operation, but with different inputs. To illustrate by way of an example, the hash units 221-224 each may include XOR logic to perform a bit-wise XOR function using the same subset of bits of the branch history value and different subsets of bits of the address value. In some embodiments, some or all of the hash units 221-224 may perform a different hash function with the same or different inputs. To illustrate, the hash unit 221 may include XOR logic to perform an XOR function using a subset of bits of the branch history value and a subset of bits of the address value, the hash unit 222 may include concatenation logic to perform a concatenation function of a subset of bits of the branch history value and a subset of bits of the address value as the most significant bits and least significant bits, respectively, of the hash result value, the hash unit 223 may include concatenation logic to perform a concatenation function of a subset of bits of the address value and a subset of bits of the branch history value as the most significant bits and least significant bits, respectively, of the output hash result value, and the hash unit 224 may include XOR logic to perform an XOR function using the same subset of bits of the branch history value but a different subset of bits of the address value compared to the XOR function performed by the hash unit 221.

The four hash units 221-224 concurrently generate four hash result values (also denoted as hash result values “HR1”, “HR2”, “HR3”, and “HR4”, respectively). The selection logic 216 selects the index value 210 from these four hash result values based on one or both of the branch history value and the branch address value. To illustrate, the selection logic 216 can include a multiplexer 226 having a plurality of inputs coupled to the outputs of the hash units 221-224 to receive the generated hash result values HR1-HR4, an input to receive a selection input value, and an output to provide a select one of the input hash result values HR1-HR4 as the index value 210 input to the branch prediction table 204 based on the selection input value.

To provide the selection input value, in some embodiments, the selection logic 216 employs another hash unit 228 that performs a hash operation by applying a hash function to a subset of bits of the branch history value and a subset of bits of the address value to generate a hash result value (denoted “SEL”), which in turn is used as the selection input value of the multiplexer 226. The hash unit 228 differs from the hash units 221-224 based on inputs, hash function applied, or both. To illustrate, in some embodiments, the hash unit 228 applies a hash function to a subset of bits of the branch history value and a subset of bits of the address value that are not used by the hash units 221-224. As described below, the use of a hash operation based on the branch history value and the address value to select between the other hash result values permits broader participation of all of the entries 208 of the branch prediction table 204 in the prediction training process and reduces the potential for the branch instructions of a workload to alias into only a small subset of the entries 208 of the branch prediction table 204.

The multiple-hash indexing of the illustrated branch predictor 114 can be more generally described as follows: given a branch history value that is N-bits long (that is, covers N previous branches) and a branch prediction table 204 having 2^{K} entries 208 (K<N), an index value 210 of K bits is needed to index the entire 2^{K} entry space of the branch prediction table 204. Thus, indexing logic 202 can implement 2^{(N-K)} hash units to generate 2^{(N-K)} hash result values. Each hash unit performs a hash operation using K bits of the branch history value and a corresponding subset of bits of the address value (where the number of bits used from the address value depends on the hash operation implemented). The hash units may implement the same hash functions or different hash functions. The hash unit 228 of the selection logic 216 performs a hash operation using (N-K) bits of the branch history value and some number of bits of the address value to generate the hash result value that is used to select the K-bit index value 210. In some embodiments, the N-K bits of the branch history value are not used by any of the 2^{(N-K)} hash units, thus effectively allowing a 2^{K}-entry bit branch prediction table 204 to capture correlations of branch directions for a branch history of up to N bits (that is, N prior branch occurrences). Thus, the size of the branch prediction table 204 can be reduced by a factor of 2^{(N-K)} relative to single hash indexing applications while retaining the same correlation information and accuracy.

To illustrate, assuming a 14 bit global history (N=14) and four hash units (2^{N-K}=4, K=12), each hash unit performs a hash operation using twelve bits of the branch history value and a corresponding subset of bits of the address value to generate four 12-bit hash result values, HR1-HR4. The hash unit 228 of the selection logic can perform an XOR operation of the unused two bits of the branch history value and two unused bits of the address value to generate the two-bit hash result SEL, which is used by the multiplexer 226 to select the 12-bit index value 210 from among the four 12-bit hash result values HR1-HR4. Thus, the branch prediction table 204 can be implemented with only 2¹² entries 208, whereas conventional single-hash index approaches using a 14-bit branch history value would require a branch prediction table of 2¹⁴ entries, most of which would not be utilized due to the aliasing often found in the application of a single-hash indexing to many instruction workloads. Thus, this approach enables the use of a branch prediction table 204 that is ¼^{th} the size that would be necessary in a conventional single-hash indexing approach, thereby saving power and silicon area.

Although a particular application of the table-indexing technique was described above in the context of a two-level adaptive branch predictor, this technique also can be adapted for use in any of a variety of hash table applications, such as indexing a branch target buffer (BTB) for branch target prediction, indexing a code term table in an encryption application, and the like. Moreover, although the example implementation described above is in the context of hardcoded hardware of a processor, the multiple-hash indexing techniques also may be implemented by one or more processors executing one or more software programs tangibly stored at a computer readable medium, whereby the one or more software programs comprise executable instructions that, when executed, manipulate the one or more processors to perform one or more functions described above. To illustrate, the indexed table can be implemented as a memory-based data structure maintained by the executed software and the processor, the hash units generating the hash result values can be implemented as software operations of the executed software and the processor, and the selection logic 216 that selects among the generated hash result values likewise can be a software operation of the executed software and the processor.

In some embodiments, the components and techniques described above are implemented in a system comprising one or more integrated circuit (IC) devices (also referred to as integrated circuit packages or microchips. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

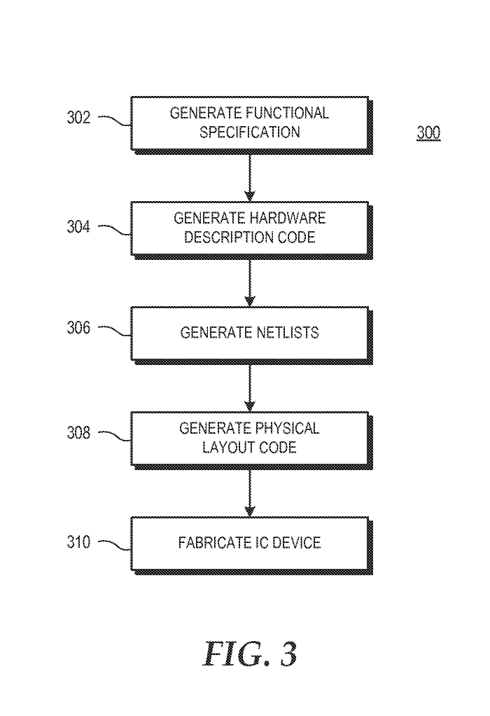

FIG. 3 is a flow diagram illustrating an example method 300 for the design and fabrication of an IC device implementing one or more aspects described above. As noted above, the code generated for each of the following processes is stored or otherwise embodied in computer readable storage media for access and use by the corresponding design tool or fabrication tool.

At block 302 a functional specification for the IC device is generated. The functional specification (often referred to as a micro architecture specification (MAS)) may be represented by any of a variety of programming languages or modeling languages, including C, C++, SystemC, Simulink™, or MATLAB™.

At block 304, the functional specification is used to generate hardware description code representative of the hardware of the IC device. In at some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 306 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 308, one or more EDA tools use the netlists produced at block 306 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 310, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
performing a plurality of hash operations at a processor using a first value and a second value to generate a plurality of hash result values;
selecting a hash result value from the plurality of hash result values based on a hash result value of another hash operation performed at the processor using the first value and the second value; and
indexing an entry of a table based on the selected hash result value.

2. The method of claim 1, wherein the plurality of hash operations implement at least two different hash functions.

3. The method of claim 1, wherein the plurality of hash operations use at least two different subsets of bits of the first value.

4. The method of claim 1, wherein the plurality of hash operations implement at least two different hash functions and at least two different subsets of bits of the first value.

5. The method of claim 1, wherein the other hash operation is performed using a subset of bits of the first value that is not used by the plurality of hash operations.

6. The method of claim 1, wherein:
the first value comprises a branch history value representing a history of branch directions at the processor;
the second value comprises an address value associated with a branch instruction;
the table comprises a branch prediction table comprising a plurality of entries, each entry storing a prediction value indicating a predicted taken/not-taken direction; and
the method further comprises:
executing an instruction stream at the processor responsive to a prediction value stored at the entry of the branch prediction table indexed by the selected hash result value.

7. A method comprising:
predicting, at a processor, whether a branch instruction is taken based on a prediction value stored at an entry of a branch prediction table indexed by an index value selected from a plurality of values concurrently generated from an address value of the branch instruction and a branch history value representing a history of branch directions at the processor.

8. The method of claim 7, further comprising:
executing an instruction stream at the processor responsive to predicting whether the branch instruction is taken.

9. The method of claim 7, further comprising:
concurrently performing a plurality of hash operations at the processor using the branch history value and the address value to generate the plurality of values; and
selecting the index value from the plurality of values based on at least one of the address value and the branch history value.

10. The method of claim 9, wherein the plurality of hash operations implement at least two different hash functions.

11. The method of claim 9, wherein the plurality of hash operations use at least two different sets of bits of the branch history value.

12. The method of claim 11, wherein selecting the index value from the plurality of values comprises selecting the index value based on a hash operation performed using a subset of bits of the address value and a subset of bits of the branch history value that was not used in performing the plurality of hash operations.

13. The method of claim 9, wherein:
the branch history value has N bits, N being an integer greater than 1;
the branch prediction table has 2^{k} entries, K being an integer greater than 1 and less than N;
the plurality of hash operations is 2^{(N-K)} hash operations, wherein each hash operation uses a subset of K bits of the branch history value and generates a corresponding index value having K bits; and
selecting the index value from the plurality of values comprises selecting the index value based on a hash operation performed using a subset of N-K bits of the branch history value that were not used in performing the plurality of hash operations.

14. A processor comprising:
a first storage element to store a first value;
a second storage element to store a second value;
a plurality of hash units coupled to the first and second storage elements, each hash unit to perform a hash operation using the first value and the second value to generate a corresponding hash result value; and
selection logic to select a hash result value from the hash result values generated by the plurality of hash units responsive to a selection input generated from another hash operation performed using the first value and the second value.

15. The processor of claim 14, wherein the plurality of hash units implement at least two different hash functions.

16. The processor of claim 15, wherein the plurality of hash units use at least two different subsets of bits of the first value.

17. The processor of claim 15, wherein the other hash operation is performed using a subset of bits of the first value that is not used by the plurality of hash units.

18. The processor of claim 14, wherein the plurality of hash units use at least two different subsets of bits of the first value.

19. The processor of claim 14, wherein:
the first value comprises a branch history value representing a history of branch directions at the processor;
the second value comprises an address value associated with a branch instruction;
the hash result value comprises an index value; and
the processor further comprises:
a branch predictor to access a prediction value stored at an entry of a branch prediction table indexed by the index value; and
an execution pipeline to execute an instruction stream responsive to the prediction value.

20. The processor of claim 19, wherein:
the branch history value has N bits, N being an integer greater than 1;
the branch prediction table has 2^{k} entries, K being an integer greater than 1 and less than N;
the plurality of hash units is 2^{(N-K)} hash units, wherein each hash unit uses a subset of K bits of the branch history value and generates a corresponding hash result value having K bits; and
the selection logic is to select the index value from the hash result values generated by the plurality of hash units using a subset of N-K bits of the branch history value that were not used in performing the plurality of hash operations.
